(19) United States
(12) Patent Application Publication
(10) Pub. No.: US 2015/0125712 A1
(43) Pub. Date: May 7, 2015

(54) COMPOSITIONS AND METHODS FOR RESISTING DISCOLORATION OF WOOD AND TREATED WOOD

(71) Applicant: KOP-COAT, INC., PITTSBURGH, PA (US)

(72) Inventors: RONALD WALTON CLAWSON, MONROEVILLE, PA (US); CHARLES NORMAN CHEEKS, OAKMONT, PA (US); ALAN S. ROSS, BOYNTON BEACH, FL (US)

(73) Assignee: KOP-COAT, INC., PITTSBURGH, PA (US)

(21) Appl. No.: 14/538,257

(22) Filed: Nov. 11, 2014

Related U.S. Application Data
(62) Division of application No. 13/455,843, filed on Apr. 25, 2012, now abandoned.

(51) Int. Cl. B27K 3/50; B05D 7/06; B27K 5/02; C09D 5/00

(52) U.S. Cl. CPC B27K 3/50; C09D 5/00; B05D 7/06; B27K 5/02
USPC 428/541; 106/287.25; 106/287.26; 427/393

(57) ABSTRACT

A solution and method of treating wood to resist discoloration of the wood and the treated wood employ a polydentate monoamino carboxylic acid and/or a diakyl diphosphonic acid. The invention resists discoloration which is believed to be caused by the mobility of organic based chromophoric molecules within the wood which migrate toward the surface of the wood. Among uses of the invention, it is particularly helpful in effecting resistance to discoloration of wood being treated with wood preservatives, stains and coatings. In another embodiment, ammonium pentaborate may be employed to resist discoloration.

### BACKGROUND OF THE INVENTION

1. Field of the Invention

The present invention relates to a method of effectively resisting undesired discoloration of wood and wood products and, more specifically, it relates to such a method which employs a polydentate amino carboxylic acid and/or a dialkyl diphosphonic acid in wood preservative solutions including, but not limited to, those treated with wood preservative solutions, stains or coatings to resist unwanted discoloration of wood and wood products.

2. Description of the Prior Art

Various species of wood are known to discolor during their life cycles. This discoloring, which may be artificially accelerated by the introduction of wood preservation chemicals and/or from the inherent weathering of the wood itself, can be attributed to the mobilization and deposition of organic based chromophoric molecules onto the outermost wood surfaces.

Chemicals used in wood preservation may include fungicides, insecticides, decay-resistant materials, stain-resisting materials, weather proofing materials, and fire retardants and combinations thereof. See, for example, U.S. Pat. Nos. 4,879,083; 4,950,685; 5,468,284; 5,763,338; 5,883,741; 5,855,817; 5,972,266; 6,416,789 and 6,582,732. These chemicals may be introduced into the wood by a number of methods including: dip application, spray application, flood coat application and pressure and vacuum methods of aqueous or solvent borne solutions, for example.

U.S. Pat. Nos. 7,896,960 and 7,655,281 disclose a method of protecting wood through enhanced penetration of wood preservatives by providing a solution which includes at least one amine oxide, at least one organic wood preservative and a buffering agent. The buffering agent may be selected from the group consisting of borates, boric acids, phosphates, calcium hydroxide, and combinations thereof.

U.S. patent application Ser. No. 13/079,905 discloses a method that permits enhanced penetration of wood preservatives through the use of solutions having a buffered pH above the pH of the wood achieved through the use of a combination of amine oxide and a non-borate buffering agent.

Historically, physical and chemical remediation techniques of wood have been largely ineffective in negating, correcting and/or resisting unwanted discolorations of the wood. These techniques include, for example, chemical oxidation, photo-oxidation, photochemical oxidation, chemical reduction, the inclusion of varying anti-oxidants and the inclusion of stain-blocking additives to primers and top-coats. See, for example, U.S. Pat. Nos. 4,752,354; 5,993,534; 6,113,989, 6,245,141 and 5,529,811.

In the use of known prior art systems, namely photo-oxidation, for the physical remediation of existing discoloration in wood, capital investments for the equipment needed negatively influenced the economics of these methods. Also, some prior art systems employed hazardous chemicals such as oxidizers and organometallic compounds which presented environmentally and industrially hazardous conditions. Examples of such undesirable materials are concentrated hydrogen peroxide and sodium hypochlorite.

There remains, therefore, a very real and substantial need for an alternate means of effectively resisting the discoloration of wood and wood products while having favorable economic aspects, practical application procedures and avoiding risks to human health.

### SUMMARY OF THE INVENTION

The present invention has met the hereinbefore described needs.

In a preferred embodiment, the present invention resists discoloration of wood by the inclusion of stain-blocking material(s) in a primer, coating or top-coat that is applied to the wood surface. The remediation of discolored wood to resist additional discoloration is typically realized through physical or chemical methods or a combination of both methods. In a preferred embodiment, the stain blocking solution is introduced in combination with a wood preservative which penetrates into the interior of the wood so as to resist movement and deposition of organic based chromophoric molecules onto the wood surface, thereby contributing to undesired discoloration. When employed with a wood preservative, the stain blocking additive is preferably mixed with the wood preservative prior to application, but in a less preferred approach, may be applied to the wood for penetration thereinto before or after the wood preservative is introduced. The stain blocking materials may also be used apart from use with wood preservatives to resist the undesired discoloration of the wood.

It has now been found that polydentate amino carboxylic acid and/or a dialkyl diphosphonic acid deposited in the wood have a marked ability to negate discolorations caused by the mobility of organic chromophoric molecules.

While either the polydentate amino carboxylic acid or the dialkyl phosphonic acid may be employed separately in the discoloration resistant additive solution of the present invention, it is preferred that a combination of the two be employed. All the percentages mentioned refer to a weight to weight ratio. i.e. mass of additive to mass of total wood preservative solution. The polydentate amino carboxylic acid may be employed in a weight percent based on the entire wood preservative solution of about 0.1 to 15% and preferably about 0.1 to 10%. The dialkyl diphosphonic acid may be employed in the range of 0.1 to 10% weight percent and preferably about 1 to 5.0% of the weight of the total wood preservative solution. These percentages would apply whether the discoloration resisting additive is introduced into the wood preservative before it is applied to the wood or it is provided shortly before or shortly after the wood preservative is applied. The preferred approach would be to introduce the discoloration resisting solution into the wood preservative prior to application to the wood. In instances where the discoloration resisting additive is applied to wood where no wood preservative is being added at that time, the polydentate amino carboxylic acid may be mixed with the dailkyl diphosphonic acid with the former being present in an amount of about 0.1 to 5 percent and the latter being applied in the amount of about 1 to 3 percent all based upon the total weight of the discoloration resistant additive.

In instances where polydentate amino carboxylic acid is employed without the dailkyl diphosphonic acid, it may be employed in about 0.1 to 15 weight percent based upon the total wood preservative solution and preferably about 0.1 to 10 percent. Where the dailkyl diphosphonic acid is employed alone, it may be employed in the range of about 0.1 to 10 weight percent based upon the total wood preservative solution weight and preferably about 1 to 5 percent.

The method of the present invention permits the resisting of discoloration in wood and wood products through the inclusion of polydentate amino carboxylic acid and/or a dialkyl diphosphonic acid in the wood preservation solution, stain or coating to resist the migration of unwanted chromophoric molecules to wood surface and subsequent discoloration. While a coating would not provide the preferred depth of penetration such as presented by a wood preservation solution or stain, it, nevertheless, through a small amount of penetration or retention on the surface, provides some of the discoloration resistant benefits of the present invention.

The wood preservative solution containing this polydentate amino carboxylic acid and/or a dialkyl diphosphonic acid would be used to impregnate the key chemicals described herein which are introduced into the wood.

Accordingly, this invention relates to a method of protecting wood against discoloration by treatment with a wood preservative, stain, coating, or impregnation of the wood comprising at least one acid selected from the group consisting of polydentate monoamino carboxylic acid of formula I and polydentate polyamino carboxylic acid of formula II and a dialkyl diphosphonic acid of formula III.

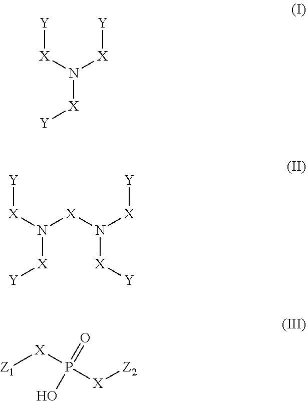

where,
X is independent and can be linear, branched, cyclic, aromatic or any combination thereof saturated or unsaturated C1 to C20 group and any C1-C20 carbon atom can be replaced with a heteroatom selected from the group consisting of O, S, Si and N.
Y is a carboxylic acid group or a carboxylate anion paired with any metallic or nonmetallic cation.
Z1 and Z2 are each a methyl group, or Z₁ and Z2 together may form a linking moiety which may additionally be substituted by an ester, ether, hydroxyl, oxo, cyanohydrin, amide, amino, carboxy or urethane group.
N is a nitrogen atom
P is a phosphorous atom

The invention also contemplates the treating solution per se and the wood which has been so treated. In a preferred practice of the method, a wood preservative solution is created with a discoloration resisting additive with at least one acid selected from the group consisting of polydentate amino carboxylic acid and a dialkyl diphosphonic acid along with the wood preservative(s), primer or top-coat which is to be applied to the wood. This solution may have a pH of about 5 to 12.4 and preferably about 6 to 10 and most preferably about 6.5 to 8.5.

The wood preservative solution may be applied to the surface of the wood by any desired means. It is preferred that the application be at a solution temperature of 30° C. to 75° C. The wood may also be heated before and/or after application of the solution to enhance penetration of the wood preservative solution. If desired, pressure or vacuum may be employed to facilitate penetration.

It is an object of the present invention to provide solutions for resisting undesired discoloration of wood and related methods of application and wood products provided with such resistance.

It is another object that the present invention to provide such resistance to undesired discoloration through the use of at least one acid selected from the group of polydentate amino carboxylic acid and dialkyl diphosphonic acid.

It is an object of the present invention to reduce unwanted discoloration in wood when ammonium pentaborate is utilized in treating wood with or without the inclusion of the polydentate amino carboxylic acids and/or dialkyl diphosphonic acids.

It is another object of the present invention that when a plurality of wood preservatives are utilized, the depth of penetration into the wood of each may be to a different level, but in general, will allow for the deposition of the polydentate amino carboxylic acid and a dialkyl diphosphonic acid below the outermost surface as to resist migration of the chromophoric molecules and subsequent discoloration to the exterior surface.

It is yet another object of the present invention to provide such a method of discoloration prevention which can be applied to green lumber, i.e. lumber which contains undried sap, or other green wood-based products.

It is a further object of the present invention to provide such a method which is usable on a wide variety of types of wood.

It is another object of the present invention to provide wood preservative(s), primers or top-coats containing the polydentate amino carboxylic acid and/or a dialkyl diphosphonic acid which can be applied to the wood using dip, flood coating, spray coating, pressure or vacuum treating and brush coating.

It is yet another object of the present invention to provide such a method wherein the wood to which the solution of the present invention has been applied may be stored for a substantial period of time before additional processing without having undesired discoloration occur.

It is a further object of the present invention to provide a solution for use in the method of the invention or a concentrate containing the desired compounds which can be diluted to create the desired solution with or without the addition of other compounds employable in the method.

It is yet another object of the present invention to provide wood characterized by resistance to undesired discoloration as a result of having been treated by the solution and method of the present invention.

It is another object of the invention to present a method for the artificial accelerated weathering of wood using a heat and humidity chamber for discoloration evaluations; wherein, a qualitative, color based ranking system is utilized to report the severity of yellowing.

It is another object of the invention to permit the discoloration resisting material of the present invention to be mixed with wood preservative materials in a solution prior to application of the solution to the wood or, if desired, the discoloration resisting material may be applied before or after the wood preservative materials.

### DESCRIPTION OF THE PREFERRED EMBODIMENTS

As employed herein, the term “wood” means wood, wood-based materials, wood fiber materials, forest products, timber, lumber, green lumber, engineered wood, millwork, joinery, wood laminates, laminated veneer lumber, plywood, laminated strand lumber, wood fiber composites, medium density fiberboard, particle board, hard board, oriented strand board, wood fiber resin composites, wood strand resin composites, wood particle resin composites and other wood and wood fiber-based materials and fabricated and semi-fabricated products made therefrom.

As employed herein, the term “wood preservative” means organic compounds, halo-organic compounds, metalo-organic compounds, organo-salts, metal salts, borates, organophosphates and non-organoboron compounds having fungicidal, insecticidal, water-resistant, termite-resisting, decay-resisting, stain-resisting or other wood-protective properties.

As employed herein, the term “wood preservative solution” means an organic solvent or aqueous based solution, emulsion or dispersion containing a wood preservative or combination of wood preservatives and optionally, in addition, chemicals such as suitable solvents, amine oxides, water repellents, waxes, polymers, silicones, coloring agents or dyes may be included.

As employed herein, the term “stain” refers to any organic solvent or aqueous based solution that contains colorants intended to alter the surface color of wood.

As employed herein, the term “coating” refers to any organic or aqueous based resin system that is intended to serve as a thin film protective layer to the wood surface and includes primer paints, top-coat paints, sealants, shellacs, varnish, enamel paints and any paint product intended for final use as a dry film coating after application.

As used herein, the term “polydentate amino carboxylic acid” refers to those compounds which are formed as reaction products of amines, aldehydes and cyanides and are represented by the general formula(s) I and II.

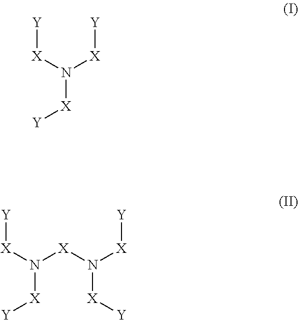

As used herein, the term “dialkyl diphosphonic acid” refers to those compounds which are formed as reaction products from the condensations of aldehydes and polyalkyl phosphites or from transesterfication and are represented by the general formula III.

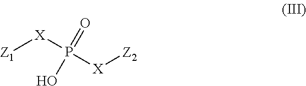

where,
X is independent and can be linear, branched, cyclic, aromatic or any combination thereof saturated or unsaturated C1 to C20 group and any C1-C20 carbon atom can be replaced with a heteroatom selected from the group consisting of O, S, Si and N.
Y is a carboxylic acid group or a carboxylate anion paired with any metallic or nonmetallic cation.
Z1 and Z2 are each a methyl group, or Z₁ and Z₂ together may form a linking moiety which may additionally be substituted by an ester, ether, hydroxyl, oxo, cyanohydrin, amide, amino, carboxy or urethane group.
N is a nitrogen atom
P is a phosphorous atom

Preferred polydentate amino carboxylic acids are nitrilotriacetic acid, ethylene diaminetetraacetic acid and diethylene triaminepentaacetic acid.

In a preferred method of the present invention, a wood preservative solution, stain or top-coat contains a combination of the polydentate amino carboxylic acid and a dialkyl diphosphonic acid having a pH of about 4 to 12.5 and preferably about 5 to 10 and most preferably about 6.5 to 8.

If desired, the compounds listed in this invention may be provided in concentrate form in a solution, slurry, emulsion or dispersion utilizing a suitable solvent, such as water, with the final solution to a be applied being created by adding additional solvent and mixing the same in order to minimize shipping and storing of the volume required to make up the difference between the concentrate solvent volume and the final solvent volume.

The wood preservative solution, stain or coating preferably contains about 0.10 to 15 weight percent based on weight of the total solution of one or more of the polydentate amino carboxylic acids and most preferably about 0.1 to 10 weight percent based on weight of the total solution , in addition to about 0.10 to 10 weight percent based on weight of the total solution of one or more of the dialkyl diphosphonic acids and most preferably about 1 to 5 weight percent, all based on mass of total solutions.

If either acid is used alone the ranges would remain the same, but the amount used would preferably be within the upper portion of the range.

The presence of ammonium pentaborate reduces the severity of yellowing when paired with additive chemicals of the invention, the reduction in severity is amplified. It is preferred that the ammonium pentaborate be employed in about 0.1 to 2% and preferably about 5 to 15% of the total solution and weight basis whether the solution contains a wood preservative and/or the discoloration additive.

We believe that some chemical interactions between the polydentate amino carboxylic acids and phosphonic acids with the hydoroxyl groups present in the chromophoric molecules exist. These interactions would assist in binding the molecules to the cellulose backbone present in the wood and reduce migration of the chromophoric molecules to the wood surface.

The wood preservative may be present in the wood preservative solution in about 3 ppm to 50 weight percent based on weight of total solution and preferably about 20 ppm to 5,000 ppm. The wood preservative solution, stain or top-coat is in water or organic solvents such as ethanol or ethylene glycol, for example.

The materials may be provided in the form of a concentrate which will be diluted prior to application to achieve the forgoing relationships.

The wood preservative solution, stain or coating may be applied to the wood by any desired means such as spraying, rolling on or dipping, for example. For example, if desired, pressure or vacuum can be used to deliver the wood preservative solution containing the polydentate amino carboxylic acid and/or a dialkyl diphosphonic acid. The wood so treated, may be stored for a period of time before additional processing. For example, the wood may be covered for about 12 to 24 hours after application to the wood which is at about 12° C. to 100 ° C.

Application may be achieved at any temperature between ambient and boiling temperature, but in the preferred approach to this invention, application of the wood preservative solution containing the polydentate amino carboxylic acid and/or dialkyl diphosphonic acid will be achieved at a temperature of about 30° C. to 75° C. and most preferably at a temperature of about 40° C. to 65° C.; application of stains or coatings containing the about 30° C. to 75° C. will be preferably achieved at about 25° C. to 40° C. It is preferred to heat the wood to about 8° C. to 230° C. prior to application and most preferably about 12° C. to 100° C.

It will be appreciated that when the solid polydentate amino carboxylic acid is to be incorporated into a stain or primer, the compounds would best be incorporated by grinding with the pigments and/or dispersed solid particles found with the liquid coating.

It will be appreciated that more than one wood preservative solution, stain or coating may be employed and the ranges set forth herein refer to each category with a single compound or category of compounds.

The method of the present invention may be practiced in an in-line manner to process the wood efficiently or in a pressure-vacuum impregnation method with the method effecting unwanted discoloration of wood.

The wood may be engineered wood or laminated wood having a glued layer or substantial amount of glue or resin therein with the method effecting unwanted discoloration of wood.

The method may be performed on wood with any amount of moisture content including green (wet) wood and on wood which has moisture at a level which does not exceed the fiber saturation point of the wood and on dry wood.

The propensity for discoloration of wood may be evaluated utilizing accelerated heat and humidity in a chamber designed to operate at 60° C. (±3° C.) oven at ≧95% relative humidity over a standard test duration of 168 h. To accurately quantify any reduction in discolorations, white-primer 3-5 wet mils thick was applied on the sample boards to serve as a standard background for color comparison prior to the torture testing. Results from this accelerated torture are quantified utilizing an assigned color ranking scale of 0-15 where any affected surface area of the wood is noted. Colors for comparison were taken from standard commercial colorants that range from light yellow to dark brown. To ensure that the data captured both heartwood and sapwood, any minor discoloration was recorded as an overall sample discoloration. A minimum of seven separate samples was scored and averaged to one composite score for reporting herein.

TABLE 1
Commercial Color Codes and Correlation
to Inventors Discoloration Ranking

| Commercial | |
|---|---|
| Color Code | Ranking |
| No | 0 |
| Discoloration | |
| BHG601 | 1 |
| BHG602 | 2 |
| BHG603 | 3 |
| BHG604 | 4 |
| BHG605 | 5 |
| BHG606 | 6 |
| BHG607 | 7 |
| BHG608 | 8 |
| BHG609 | 9 |
| BHG610 | 10 |
| BHG611 | 11 |
| BHG612 | 12 |
| BHG613 | 13 |
| BHG614 | 14 |
| BHG615 | 15 |

In Table 1, the first column contains references to a commercially available color code with the Ranking being established as correlating with the various color standards. The indication of “No Discoloration” was given the ranking of 0, the next higher level of discoloration designated BHG601 was given a ranking of 1. As the numbers increase in ranking, the yellow background with Table 1, discoloration became more intense. As a result, the BHG (Better Homes & Gardens) standard related to hues of yellow which is the predominate color experience with discoloration of wood was employed These tests were made against a white background by comparing the discoloration on the white.

### EXAMPLES

In order to provide an enhanced understanding of the invention, examples will be provided. For each experiment, samples included both painted and unpainted untreated samples extracted from one parent board for ultimate comparison. For each specific example shown below, the data contains comparisons to average discoloration ratings on primed boards of both untreated samples and samples treated with the exact wood preservative solution without use of the compounds of this invention.

As sugar pine is a type of wood known to create undesired discoloration problems, it was selected for use in the present examples. Other woods which are highly susceptible to undesired discoloration are Lodgepole Pine and Douglas fir. The samples contained a fair portion of heartwood. The wood qualified as weatherboard quality. Weatherboard is a wood of decent quality and is employed for uses such as exterior trim applications on houses, for example.

Only one half of the sample was painted with a white primer 3-5 wet mils thick in order to provide a constant material background for evaluating the degree of discoloration on the white portion of the sample. This was employed in conjunction with the Table 1 color chart with visual evaluation being employed. The remainder of the board was left unpainted so as to facilitate evaluation of the surface after subjecting it to heat/humidity accelerated testing. Throughout the examples, the test boards were all subjected to accelerated weathering prior to subjecting them to the test cycles in order to produce reliable test results.

The totally untreated wood sample were subjected to the same accelerated weathering but were not immersed in the wood preservative.

The comparison of the surfaces involved (a) those samples which were treated with wood preservative and the discoloration resistant solution of the present invention, (b) those totally untreated wood samples which discolored without such treatment, and (c) those samples treated with wood preservative but not the discoloration resistant solution of the present invention.

### Example 1

A wood preservative solution containing 1062.0 grams of a borate buffered, aqueous amine-oxide containing wood preservative solution was heated to 60° C. (±2° C.) and stirred until homogeneous. 21.21 grams of nitrilotriacetic acid was added and the solution was allowed to stir at 60° C. (±2° C.) until homogeneous. Sugar Pine lumber, of the dimensions approximately 20 mm deep, 140 mm wide and 128 mm long was immersed for 1 second in the hot wood preservative solution. The samples were then placed in a suitable plastic covering for 12-24 h at 40° C. (±2° C.) before unwrapping and drying the samples for 1-2 h at room temperature and humidity. Standard commodity white primer was applied to approximately one-half of the surface area of the sample to 3-5 wet mils thickness by brush application over two coats with approximately 45 min dry time between applications of the second coat. The samples were dried for a minimum of 12 h at ambient temperature and humidity. The samples were then placed in a 60° C. (±2° F.) oven at ≧95% relative humidity for 168 h before removing and drying at room temperature for 1-2 h for comparison. In total, (a) 12 samples extracted from uniform parent boards were evaluated and an average discoloration score of 2.8; (b) Twelve untreated boards from the same uniform boards reported an average discoloration score of 2.0; and (c) Twelve samples from the same uniform boards treated with the same wood preservative solution without the compounds described in this invention reported an average discoloration score of 3.4.

It is believed that discoloration for treated samples is more severe than for untreated samples when the samples are subjected to the same accelerated weathering. Wood preservative contain ingredients which assist chemicals in getting deep into the wood. These same chemicals help things to get out. For example, a wood preservative may use a buffer to temporarily block the cellulose and lignin functionalities that can deter organic molecules from migrating into the wood. When coupled with the amine oxide carrier molecules employed in the examples this creates a good environment for enhanced penetration into the wood. During this time, chromophoric molecules are now more easily migrated to the surface because the wood is primed with the buffers and amine oxides. Eventually, the wood acids overcome the buffers and the propensity to act as normal is restored.

### Example 2

A wood preservative containing 886.0 grams of a borate buffered, aqueous amine-oxide containing wood preservative solution was heated to 60° C. (±2° C.). The solutions were heated to 60° C. (±2° C..) and stirred until homogeneous. 8.97 grams of 1-hydroxyethylidene-1, 1-diphosphonic acid was added and the solution was allowed to stir at 60° C. (+2° C.) until homogeneous. Sugar Pine lumber, of the dimensions approximately 20 mm deep, 140 mm wide and 128 mm long was immersed for 1 second in the hot wood preservative system. The samples were then placed in a suitable plastic covering for 12-24 h at 40° C. (±2° C.) before unwrapping and drying the samples for 1-2 h at room temperature and humidity. Standard commodity white primer was applied to approximately one-half of the surface area of the sample to 3-5 wet mils thickness by brush application over two coats with approximately 45 min dry time between applications of the second coat. The samples were dried for a minimum of 12 h at ambient temperature and humidity. The samples were then placed in a 60° C. (±2° F.) oven at ≧95% relative humidity for 168 h before removing and drying at room temperature for 1-2 h for comparison. In total, 12 samples extracted from uniform parent boards treated with both the wood preservative and the discoloration resistant solution of this invention were evaluated and an average discoloration score of 2.4 was evidenced. Twelve untreated boards from the same uniform boards reported an average discoloration score of 2.0. Twelve samples from the same uniform boards treated with the same wood preservative solution without the compounds described in this invention reported an average discoloration score of 3.4.

### Example 3

827.3 grams of a borate buffered, aqueous amine-oxide containing wood preservative solution was heated to 60° C. (±2° C.). The solutions were heated to 60° C. (±2° C.) and stirred until homogeneous. 16.60 grams of nitrilotriacetic acid and 8.58 grams of 1-hydroxyethylidene-1, 1-diphosphonic acid was added and the solution was allowed to stir at 60° C. (±2° C.) until homogeneous. Sugar Pine lumber, of the dimensions approximately 20 mm deep, 140 mm wide and 128 mm long was immersed for 1 second in the hot wood preservative system. The samples were then placed in a suitable plastic covering for 12-24 h at 40° C. (±2° C.) before unwrapping and drying the samples for 1-2 h at room temperature and humidity. Standard commodity white primer was applied to approximately one-half of the surface area of the 20 mm deep, 140 mm wide and 128 mm long sample to 3-5 wet mils thickness by brush application over two coats with approximately 45 min dry time between applications of the second coat. The samples were dried for a minimum of 12 h at ambient temperature and humidity. The samples were then placed in a 60° C. (±2° F.) oven at ≧95% relative humidity for 168 h before removing and drying at room temperature for 1-2 h for comparison. In total, 12 samples extracted from uniform parent boards treated with both the wood preservative and the discoloration resistant solution of this invention were evaluated and an average discoloration score of 2.4 was evidenced. Twelve untreated boards from the same uniform boards reported an average discoloration score of 2.0. Twelve samples from the same uniform boards treated with the same wood preservative solution without the compounds described in this invention reported an average discoloration score of 3.4.

### Example 4

978.44 grams of a borate buffered, aqueous amine-oxide containing wood preservative solution was heated to 60° C. (±2° C.). The solutions were heated to 60° C. (±2° C.) and stirred until homogeneous. 20.30 grams of ethylene diaminetetraacetic acid and 10.00 grams of 1-hydroxyethylidene-1, 1-diphosphonic acid was added and the solution was allowed to stir at 60° C. (±2° C.) until homogeneous. Sugar Pine lumber, of the dimensions approximately 20 mm deep, 140 mm wide and 128 mm long was immersed for 1 second in the hot wood preservative system. The samples were then placed in a suitable plastic covering for 12-24 h at 40° C. (±2° C.) before unwrapping and drying the samples for 1-2 h at room temperature and humidity. Standard commodity white primer was applied to approximately one-half of the surface area of the sample to 3-5 wet mils thickness by brush application over two coats with approximately 45 min dry time between applications of the second coat. The samples were dried for a minimum of 12 h at ambient temperature and humidity. The samples were then placed in a 60° C. (±2° F.) oven at ≧95% relative humidity for 168 h before removing and drying at room temperature for 1-2 h for comparison. In total, 12 samples extracted from uniform parent boards treated with both the wood preservative and the discoloration resistant solution of this invention were evaluated and an average discoloration score of 3.1 was evidenced. Twelve untreated boards from the same uniform boards reported an average discoloration score of 2.0. Twelve samples from the same uniform boards treated with the same wood preservative solution without the compounds described in this invention reported an average discoloration score of 3.4.

### Example 5

1270.22 grams of a boric oxide buffered, aqueous amine-oxide containing wood preservative solution was heated to 60° C. (±2° C.). The solutions were heated to 60° C. (±2° C.) and stirred until homogeneous. 81.10 grams of ammonium pentaborate was added and the solution was stirred until homogeneous. 27.21 grams of nitrilotriacetic acid and 13.64 grams of 1-hydroxyethylidene-1, 1-diphosphonic acid was added and the solution was allowed to stir at 60° C. (+2° C.) until homogeneous. Sugar Pine lumber, of the dimensions approximately 20 mm deep, 140 mm wide and 128 mm long was immersed for 1 second in the hot wood preservative system. The samples were then placed in a suitable plastic covering for 12-24 h at 40° C. (±2° C.) before unwrapping and drying the samples for 1-2 h at room temperature and humidity. Standard commodity white primer was applied to approximately one-half of the surface area of the sample to 3-5 wet mils thickness by brush application over two coats with approximately 45 min dry time between applications of the second coat. The samples were dried for a minimum of 12 h at ambient temperature and humidity. The samples were then placed in a 60° C. (±2° F.) oven at ≧95% relative humidity for 168 h before removing and drying at room temperature for 1-2 h for comparison. In total, 12 samples extracted from uniform parent boards treated with both the wood preservative and the discoloration resistant solution of this invention were evaluated and an average discoloration score of 2.6 was evidenced. Twelve untreated boards from the same uniform boards reported an average discoloration of 2.0. Twelve samples from the same uniform boards treated with the same wood preservative solution without the compounds described in this invention reported an average discoloration score of 33.

### Example 6

1050.0 grams of a water-emulsifiable, solvent-borne wood preservative solution sold under the trademark Waterborne Milltreat 111 by Kop-Coat, Inc. was tempered to 25° C. (±3° C.). 20.9 grams of nitrilotriacetic acid and 10.7 grams of 1-hydroxyethylidene-1, 1-diphosphonic acid was added and the solution was allowed to stir at 25° C. (±3° C.) until homogeneous. Sugar Pine lumber, of the dimensions approximately 49 mm wide by 149 mm long by 19 mm deep was immersed for 15 second in the wood preservative system. The samples were then allowed to stand in chemical hood for 12 h at 25° C. (±3° C.). Standard commodity white primer was applied to approximately one-half of the surface area of the sample to 3-5 wet mils thickness by brush application over two coats with approximately 45 min dry time between applications of the second coat. The samples were dried for a minimum of 12 h at ambient temperature and humidity. The samples were then placed in a 60° C. (±2° F.) oven at ≧95% relative humidity for 168 h before removing and drying at room temperature for 1-2 h for comparison. In total, 7 samples extracted from uniform parent boards treated with both the wood preservative and the discoloration resistant solution of this invention were evaluated and an average discoloration score of 2.5 was evidenced. The untreated samples were evaluated and an average discoloration of 3.2 was shown. Seven samples from the same uniform boards treated with the same wood preservative solution without the compounds described in this invention reported an average discoloration score of 3.0. The variations in these results is attributable to the different wood that was utilized and the variability and unpredictable nature of the final discoloration in an ever changing medium such as wood.

### Example 7

1000.5 grams of a solvent-borne wood preservative solution sold under the trademark Woodlife 111 by Kop-Coat, Inc. was tempered to 25° C. (±3° C.). 20.1 grams of nitrilotriacetic acid and 10.0 grams of 1-hydroxyethylidene-1, 1-diphosphonic acid was added and the solution was allowed to stir at 25° C. (±3° C.) until homogeneous. Sugar Pine lumber, of the dimensions approximately 49 mm wide by 149 mm long by 19 mm deep was immersed for 15 second in the wood preservative system. The samples were then allowed to stand in chemical hood for 12 h at 25° C. (±3° C.). Standard commodity white primer was applied to approximately one-half of the surface area of the sample to 3-5 wet mils thickness by brush application over two coats with approximately 45 min dry time between applications of the second coat. The samples were dried for a minimum of 12 h at ambient temperature and humidity. The samples were then placed in a 60° C. (±2° F.) oven at ≧95% relative humidity for 168 h before removing and drying at room temperature for 1-2 h for comparison. In total, 7 samples extracted from uniform parent boards treated with both the wood preservative and the discoloration resistant solution of this invention were evaluated and an average discoloration score of 2.5 was evidenced. Seven samples from the same uniform boards treated with the same wood preservative solution without the compounds described in this invention reported an average discoloration score of 3.0.

### Example 8

This example shows how the undesired discoloration solution additive of the present invention can be incorporated into a wood preservative system which in turn can be placed in a primer system used on the same treated wood. 827.3 grams of a borate buffered, aqueous amine-oxide containing wood preservative system was heated to 60° C. (±2° C.). The solutions were heated to 60° C. (±2° C.) and stirred until homogeneous. 16.60 grams of nitrilotriacetic acid and 8.58 grams of 1-hydroxyethylidene-1, 1-diphosphonic acid was added and the solution was allowed to stir at 60° C. (±2° C.) until homogeneous. Sugar Pine lumber, of the dimensions approximately 49 mm deep by 149 mm long by 19 mm deep was immersed for 1 second in the hot wood preservative system. The samples were then placed in a suitable plastic covering for 12-24 h at 40° C. (±2° C.) before unwrapping and drying the samples for 1-2 h at room temperature and humidity. 1000 grams of standard commodity white primer was stirred at 25° C. (±3° C.) while 20.5 grams of nitrilotriacetic acid was added and stirred until homogeneous. No impractical increase in working viscosity was noted. For best results, the additive can be added during the pigment grinding process for better incorporation. The primer containing the additive was applied to approximately one-half of the surface area of the sample to 3-5 wet mils thickness by brush application over two coats with approximately 45 min dry time between applications of the second coat. The samples were dried for a minimum of 12 h at ambient temperature and humidity. The samples were then placed in a 60° C. (+2° F.) oven at ≧95% relative humidity for 168 h before removing and drying at room temperature for 1-2 h for comparison. In total, 7 samples extracted from uniform parent boards treated with both the wood preservative and the discoloration resistant solution of this invention were evaluated and an average discoloration score of 4.3 was evidenced. Seven samples from the same uniform boards treated with the same coating (primer) without the compounds described in this invention reported an average discoloration score of 4.4.

### Example 9

827.3 grams of a borate buffered, aqueous amine-oxide containing wood preservative solution was heated to 60° C. (±2° C.). The solutions were heated to 60° C. (±2° C.) and stirred until homogeneous. 16.60 grams of nitrilotriacetic acid and 8.58 grams of 1- hydroxyethylidene-1, 1-diphosphonic acid was added and the solution was allowed to stir at 60° C. (±2° C.) until homogeneous. Sugar Pine lumber, of the dimensions approximately 49 mm deep by 149 mm long by 19 mm deep was immersed for 1 second in the hot wood preservative system. The samples were then placed in a suitable plastic covering for 12-24 h at 40° C. (±2° C.) before unwrapping and drying the samples for 1-2 h at room temperature and humidity. The samples were dried for a minimum of 12 h at ambient temperature and humidity. 1500.0 grams of standard commercially-available, clear-coat shellac was stirred at 25° C. (±3° C.) while 30.5 g of nitrilotriacetic acid was added and stirred for 15 min. The shellac containing the additive was applied to approximately one-half of the surface area of the 20 mm deep, 140 mm wide and 128 mm long sample to 3-5 wet mils thickness by single dip application with approximately 45 min dry time. 1000 grams of standard commodity white primer was stirred at 25° C. (±3° C.) while 20.5 grams of nitrilotriacetic acid was added and stirred until homogeneous. No impractical increase in working viscosity was noted. For best results, the additive can be added during the pigment grinding process for better incorporation. The primer containing the additive was applied to approximately one-half of the surface area of the sample to 3-5 wet mils thickness by brush application over two coats with approximately 45 min dry time between applications of the second coat. The samples were dried for a minimum of 12 h at ambient temperature and humidity. The samples were then placed in a 60° C. (±2° F.) oven at ≧95% relative humidity for 168 h before removing and drying at room temperature for 1-2 h for comparison. In total, 7 samples extracted from uniform parent boards treated with both the wood preservative and the discoloration resistant solution of this invention were evaluated and an average discoloration score of 4.3 was evidenced. Seven samples from the same uniform boards treated with the same coating (primer) without the compounds described in this invention reported an average discoloration score of 3.6.

It will be appreciated, therefore, that the method of the present invention provides an efficient, safe, economically feasible method of resisting unwanted discoloration in wood and wood products as a result of the unique combination of polydentate aminocarboxylic acid and dialkyl diphosphonic acid in wood preservative solutions, stains and coatings intended for application on wood and wood products.

Whereas, particular embodiments of the invention have been described herein for purposes of illustration, it will be evident to those skilled in the art that numerous variations of the details may be made without departing from the invention as set forth in the appended claims.

What is claimed is:

1. A solution for resisting undesired discoloration of wood comprising
a solvent, and
at least one acid selected from the group consisting of a polydentate monoamino carboxylic acid of formula (I). 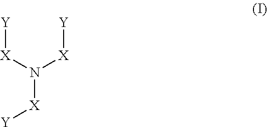
And a polydentate polyamino carboxylic acid of formula (II) 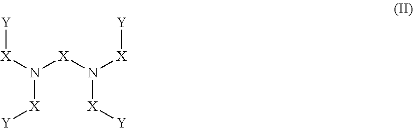
And a dialkyl diphosphonic acid of formula III. 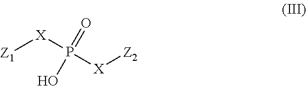
where, X is independent and can be linear, branched, cyclic, aromatic or any combination thereof saturated or unsaturated C1 to C20 group and any C1-C20 carbon atom can be replaced with a heteroatom selected from the group consisting of O, S, Si and N.
Y is a carboxylic acid group or a carboxylate anion paired with any metallic or nonmetallic cation.
Z₁ and Z₂ are each a methyl group, or Z₁ and Z₂ together may form a linking moiety which may additionally be substituted by an ester, ether, hydroxyl, oxo, cyanohydrin, amide, amino, carboxy or urethane group.
N is nitrogen atom
P is a phosphorous atom

2. The solution of claim 1 including said solution also containing a wood protective material selected from the group consisting of wood preservatives, stains and coatings.

3. The solution of claim 1 including said polydentate amino carboxylic acid being selected from the group consisting of nitrilatriacetic acid, ethylene diamine tetracetic acid and diethylene triamine pentanacetic acid.

4. The solution of claim 2 including said solution containing at least one of
(a) about 0.10 to 15 weight percent of at least one said polydentate amino carboxylic acid;
(b) 0.10 to 10 weight percent of at least one said dialkyl diphosphonic acid and said weight percentages based on the total solution weight.

5. The solution of claim 4 including said solution containing at least one of
(a) about 0.1 to 10 weight percent of at least one said polydentate amino carboxylic acid; and
(b) 1 to 5 weight percent of at least one said dialkyl diphosphonic acid.

6. The solution of claim 4 including
said solution containing both said polydentate amino carboxylic acid and said dialkyl diphosphonic acid.

7. The solution of claim 6 including
said solution having a pH of about 4 to 12.5.

8. The solution of claim 6 including
said solution having a pH of about 6.5 to 8.

9. The solution of claim 1 including
said solvent is water.

10. The solution of claim 1 including
said solution is in concentrate form .

11. The solution of claim 2 including
said wood protective material being a wood preservative and said wood preservative material being present in said solution in about 3 ppm to 50 weight percent based on weight of total solution.

12. The solution of claim 11 including said wood preservative present in about 20 ppm to 5,000 ppm.

13. The solution of claim 1 including
said wood solution also containing ammonium pentaborate.

14. The solution of claim 2 including
said wood preservative also containing ammonium pentaborate.

15. The solution of claim 1 including
said solution containing about 0.1 to 20 percent ammonium pentaborate on a weight basis based on the total solution weight.

16. The solution of claim 2 including
said solution containing about 0.1 to 20 percent ammonium pentaborate on a weight basis based on the total solution weight.

17. The solution of claim 15 including
said ammonium pentaborate being present in about 5 to 15 weight percent.

18. The solution of claim 16 including
said ammonium pentaborate being present in about 5 to 15 weight percent.

19. A method of resisting undesired discoloration of wood comprising
providing a solution for resisting undesired discoloration of wood comprising
a solvent,
at least one acid selected from the group consisting of a polydentate monoamino carboxylic acid of formula (I). 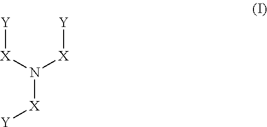
and a polydentate polyamino carboxylic acid of formula (H) 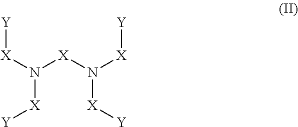
and a dialkyl diphosphonic acid of formula III. 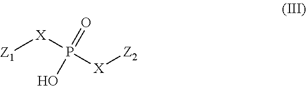
where, X is independent and can be linear, branched, cyclic, aromatic or any combination thereof saturated or unsaturated C1 to C20 group and any C1-C20 carbon atom can be replaced with a heteroatom selected from the group consisting of 0, S, Si and N.
Y is a carboxylic acid group or a carboxylate anion paired with any metallic or nonmetallic cation.
Z₁ and Z₂ are each a methyl group, or Z₁ and Z₂ together may form a linking moiety which may additionally be substituted by an ester, ether, hydroxyl, oxo, cyanohydrin, amide, amino, carboxy or urethane group.
N is a nitrogen atom
P is a phosphorous atom, and applying said solution to said wood.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. Treated wood comprising
wood treated by the method of claim 19,

39. Treated wood comprising
wood treated by the method of claim 19,

40. The wood of claim 39 including
said polydentate amino carboxylic acid being selected from the group consisting of nitrilatriacetic acid, ethylene diamine tetracetic acid and diethylene triamine pentanacetic acid.

41. The wood of claim 39 including said wood having been treated by a wood treatment solution containing at least one of
(a) about 0.10 to 10 weight percent of at least one said polydentate amino carboxylic acid; and
(b) 0.10 to 3 weight percent of at least one said dialkyl diphosphonic acid and said weight percentage based on the total solution weight.

42. The wood of claim 41 including
said wood containing at least one of
(a) about 1 to 4 weight percent of at least one said polydentate amino carboxylic acid; and
(b) 0.5 to 1.0 weight percent of at least one said dialkyl diphosphonic acid.

43. The wood of claim 41 including
said wood containing both said polydentate amino carboxylic acid and said dialkyl diphosphonic acid.

44. Treated wood comprising
wood treated by the method of claim 34.

45. Treated wood comprising
wood treated by the method of claim 36.

46. A solution for treating wood to resist undesired discoloration comprising
providing a solution having about 0.1 to 20 percent ammonium pentaborate by weight based upon total solution weight, and applying said solution to said wood.

47. The solution of claim 46 including said solution having about 5 to 15 percent ammonium pentaborate based upon total solution weight.

48. (canceled)

49. (canceled)
